(19) United States
(12) Patent Application Publication
(10) Pub. No.: US 2026/0231908 A1
(43) Pub. Date: Aug. 13, 2026

(54) COLLAR AND A METHOD OF ADJUSTING THE DIAMETER OF ITS LOOP

(71) Applicants: Ida DANILOWICZ, Pobiedziska (PL); Igor DANILOWICZ, Pobiedziska (PL)

(72) Inventors: Ida DANILOWICZ, Pobiedziska (PL); Igor DANILOWICZ, Pobiedziska (PL)

(21) Appl. No.: 19/156,767

(22) PCT Filed: Feb. 12, 2024
(86) PCT No.: PCT/IB2024/051285

§ 371 Date: Aug. 14, 2025

(30) Foreign Application Priority Data
Feb. 14, 2023 (PL) P.443781

(51) Int. Cl. A01K 27/00

(52) U.S. Cl. CPC A01K 27/001

(57) ABSTRACT

The subject of the application is a collar for pets, in particular dogs, which has the form of a strap. At the free end of the strap there is a fastener, seated in the body cavity characterized by the fact that the strap section (1) of the collar opposite to the fastener (2) is threaded through an adjustment mechanism located in the body (3). The mechanism is an arrangement of a pressure roller (8) and a shaft (6) parallel to it with a gear wheel (7) between which there is a gap for the strap material (1) of the collar, where the gear wheel (7) is driven by the rotational movement of the shaped disc (5) cooperating with it. The shaped disc (5) is set in motion by a drive source, with the rotational movement of the shaped disc (5) being blocked by a ratchet mechanism (9). The subject of the invention is also a method of adjusting the length of the collar loop realized by the torque of the drive element being translated into the rotation of the shaft (6) frictionally coupled to the belt material (1), and is then translated into the reciprocating movement of the belt material (1) of the collar.

The subject of the invention is a collar for pets, especially for dogs, with an adjustable collar loop diameter, finding a use in disciplining and training of a pet, and a method of adjusting the collar loop diameter according to the invention.

From practice and patent literature there are known collars for pets, in particular for dogs, with adjustable collar loop diameter, the collar being in the form of a variable diameter loop or a strap (or chain) clipped to form a loop using fastener-like technical means, including quick release fasteners.

For example, from patent application U.S. Pat. No. 5,456,213 there is known a collar for pets having the form of a strap, Preferably made of leather, at the first free end of which is situated the known clip hook for attaching the functional end of the leash and at the opposite free end of the strap is situated the first of the two parts of the fastener. According to the disclosure, the second part of the fastener is slidably seated on the section of the collar strap between the clip hook and the first part of the fastener, the extent of movement of the second part of the fastener along the collar strap being limited by the stitching joining a resistance element made of an additional layer of collar material situated on the section of the collar strap between the first and the second part of the collar strap.

On the other hand, patent application US20120060770 discloses a two-part collar that self-adjusts the diameter of the loop to the force exerted by the pet's neck on the collar loops when the pet pushes conventionally forward relative to the person controlling it. According to the disclosure, the collar comprises two straps, the first forming the main loop and the second forming the control loop. Both straps end at their free ends in rings, the rings of the main loop strap having an internal diameter so selected that it is possible to move them freely along the control loop strap and to pass the rings of the control loop strap through them. When the collar is used according to the disclosure, the control loop is connected by rings to the clip hook of the leash and constitutes a resistance element between the leash and the main loop of the collar. The spontaneous shortening of the diameter of the main loop of the collar takes place by stretching, due to the action of the force vector conventionally towards the front, the control ring longitudinally, resulting in bringing the rings of the main loop closer together and shortening it. Upon cessation of the force vector, the control loop relaxes and the main loop rings are pulled away from each other and the main loop is loosened. U.S. Pat. No. 5,379,726 discloses a collar, preferably in the form of a leather strap, fastened with a fastener cooperating with the openings of the opposite end of the collar strap. Conveniently, at the mid-point of the strap, the collar disclosed comprises a rigid handle in the form of a clamp for providing a person controlling the pet with a sure grip and a tightening effect on the collar loop when it is necessary to counteract undesirable behaviour of a pet provided with a collar according to the disclosure.

In addition, patent application CN110604068 discloses a collar for pets incorporating a pet location tracking system. There is a wireless signal transmitter, a GPS positioning module, a single-chip microcomputer and a power module within the body of the collar. In addition, the microcomputer has the ability to detect a break in the collar cable due to it being cut or interrupted by the pet, and to generate a signal to the pet owner informing them of such an event.

Collars known from the state of the art do not allow easy adjustment of the loop length during training or for disciplining the pet by temporarily limiting oxygen supply, on the neck of any pet or do not allow the preset loop diameter to be maintained in a constant manner (they undergo loop expansion in the absence of a force vector exerted by, for example, a trailing pet). In addition, solutions in which the diameter adjustment involves the use of holes and fasteners allow the diameter of the collar loop to be adjusted in increments that do not always coincide with the optimal diameter for the pet. The known solution also does not allow for an effective combination of functionality of the possibility to reduce or increase the diameter of the loop with a secure grip and, even more so, they are not adapted to the modern expected functionalities associated with the widely understood “smart” approach for wearable devices, i.e. they do not have wireless control capabilities, especially when it is necessary to achieve a training or disciplinary effect for a pet running without any lash.

The purpose of the invention is to develop a collar that eliminates the inconvenience known from the state of the art by providing the possibility to quickly fasten and unfasten it from the form of a strap to the form of a loop together with a smooth adjustment while maintaining the control function over the pet wearing the collar, including disciplining or training a pet running without any lash.

Unexpectedly for persons skilled in the field of technology, this goal was achieved by developing a collar equipped with a mechanism for fastening and adjusting the diameter of the collar loop and developing a way to smoothly adjust the diameter of the loop manually or using wireless communication.

According to the invention, a collar for pets, in particular dogs, is in the form of a strap, at the free end of which is situated a fastener, which is seated in a socket of the body, the body further comprising an adjustment mechanism in which the end of the collar strap opposite to the end with the fastener is seated.

An adjustment mechanism and a slot for the collar strap fastener are located in the body, with the section of the collar strap opposite the fastener threaded through the adjustment mechanism located in the body.

According to the invention, the adjusting mechanism is an arrangement of a pressure roller and a shaft parallel to it with a gear wheel, between which there is a gap for the collar strap material, the strap being frictionally coupled to the shaft and the axes of rotation of the pressure roller and the shaft being parallel to the transverse axis of the strap material. In addition, the pinion shaft is driven by the rotational movement of the shaped disc, meshing with it through the crown section of the shaped disc. In this case, the shaped disc is set in motion by a drive source, whereby the movement of the rotating disc is blocked by a ratchet mechanism and, in addition, the axis of rotation of the shaped disc is perpendicular to the axis of rotation of the pinion shaft.

The ratchet mechanism is in the form of a flat bar, conventionally ending in a release lever at the top, which is spring-loaded in such a way that the edge of the ratchet engages with the edge of the teeth of the shaped disc, preventing the shaped disc from spontaneously rotating in a direction that results in an increase in the circumference of the collar loop. In addition, the ratchet mechanism works in conjunction with a rotating lever which, in the position of use of the collar, is aligned parallel to the release lever of the ratchet mechanism. Moving the rotary lever to the lock release position has the effect of pushing the ratchet away from the tooth surface of the shaped disc, allowing the disc to rotate freely in both directions, resulting in rapid release or tightening of the collar loop. Furthermore, it is foreseen that the ratchet mechanism can be temporarily released by exerting pressure directly on the ratchet mechanism release lever, whereby when pressure is exerted, the release of the mechanism continues until the pressure is released, when the return spring presses the ratchet mechanism against the shaped disc again.

Preferably, the drive source is a handle pivotally embedded in the body of the adjustment mechanism and axially coupled to the shaping disc.

Preferably, the drive source is a DC electric motor, coupled to the shaped disc via a worm gear and powered by an accumulator, the motor, the accumulator and the gear being housed in a body, the direction of rotation of the DC motor being determined by a signal from a printed circuit board (PCB) integrated within the body, controlling the motor, the signal being received by the PCB from a wireless controller functionally coupled thereto, preferably operating in the infrared or Bluetooth band and receiving the relevant commands from an external transmitter operating in the operating band of a receiver in the body.

Preferably, the drive source is a combination of a handle axially coupled to the shaped disc and a DC motor coupled by worm gear to the shaped disc, controlled by a printed circuit board coupled to an infrared or Bluetooth receiver.

According to the invention, a receiver, operating in the infrared band, cooperates with a wireless transmitter, operating in the infrared band, with which a user controlling an pet fitted with a collar controls the adjustment mechanism of the collar for changing the diameter of its loop by transmitting signals controlling the direction of rotation of the motor constituting the source of drive of the adjustment mechanism of the collar according to the invention.

Furthermore, where the receiver is a Bluetooth receiver, the user controlling the pet fitted with the collar controls the adjustment mechanism of the collar via a smartphone/tablet/pilot application, communicating with the Bluetooth receiver and transmitting control commands to the motor which is the source of drive for the adjustment mechanism.

In all of the above configurations, i.e. using a rotating handle or using an electric drive, the torque of the drive source is transmitted via a shaped disc to a toothed wheel shaft and then, using a frictional coupling between the shaft, preferably coated with an elastomer, and the material of the collar strap-is translated into the linear movement of the collar strap. According to the invention, rotation of the shaft in the first direction has the effect of shortening the collar loop when the fastener is seated in the body socket. Rotating the shaft in the other direction has the effect of lengthening the collar loop when the fastener is seated in the body socket.

In addition, according to the invention, the collar strap fastener is conventionally shaped like an arrowhead, with a slot formed in a part coaxial with the longitudinal axis of the collar strap, dividing the fastener in a direction substantially parallel to the longitudinal axis of the collar strap into two arms. In addition, in the central part of the fastener blade, the slot transitions into a circular hole and in the opposite part of the free ends of the fastener arms, there is an opening of essentially rectangular cross-section, perpendicular to the longitudinal axis of the strap material, for inserting the fastener into the strap material of the collar.

Each of the arms of the fastener has a shaped bump substantially half way along its length, on the conventionally external side, which cooperates, when the fastener is seated in the socket, with the stop surface of the socket locking lever, located on the side of the respective arm, the socket containing two opposing levers, between which a settling channel for the fastener arms is formed and, in addition, each lever of the socket is rotatably mounted in the body through the first pins, while the locking levers are pressed against the fastener arms by the socket pressure springs exerting pressure on the second pins of the socket locking levers and seated in the body within the fastener socket, coaxially and opposite to each other.

When the fastener is seated in the socket, the arms of the fastener are seated in the retaining channel between the levers of the socket, whereby the pressure of the springs on the levers together with the engagement of the free ends of the fastener arms against the retaining surfaces of the levers prevents the spontaneous removal of the fastener from the socket. In order to release the fastener, it is necessary to exert simultaneous pressure on both levers of the socket, which has the effect of overcoming the clamping force of the pressure springs and displacing the lever thrust surfaces from the shaped arm bumps as a result of the rotation of the lever arms around the axis of their first pins, in order to release the extended free ends of the fastener arms from between the lever thrust surfaces and to pull the fastener out of the socket. Preferably, the collar strap is made of polyamide.

The method of adjusting the length of the collar loop according to the invention involves translating the torque of the drive source (handle or motor) via a shaped disc into the rotation of a shaft frictionally coupled to the strap material resulting in a reciprocating movement of the collar strap material within the adjustment mechanism for changing the diameter of the collar loop when the collar fastener is seated in the body socket. According to the invention, the torque of the drive member in the first direction of rotation is translated via the shaped disc by rotation of the shaft frictionally coupled by the thorns to the strap material into a reciprocating movement of the collar strap in the first direction, and the torque of the drive member in the second direction of rotation is translated via the shaped disc by rotation of the shaft frictionally coupled by the thorns to the strap material into a reciprocating movement of the collar strap in the second direction.

In addition, the translation of the reciprocating movement of the strap material through the rotation of the frictionally coupled shaft into the torque of the drive member is Preferably mechanically blocked when it is not desired.

Preferably, the mechanical blocking of the translation of the reciprocating movement of the strap material by the rotation of the frictionally coupled shaft into the torque of the drive member is offset by external pressure on the blocking mechanism.

The solution according to the invention fully realises the technical issue posed, eliminating the disadvantages known from the state of the art. The collar according to the invention provides a stepless adjustment of the diameter of its loop without compromising the control function of the pet and, moreover, allows the user to use wireless communication to realise a method of adjusting the diameter of the collar loop. Furthermore, the disclosed solution allows the solution to be used both for training and disciplining the pet, both when the user is in direct contact with the pet, i.e. holding the handle of the collar according to the invention in his hand when the collar is worn around the pet's neck, and when the pet wearing the collar according to the invention around its neck is running freely within the range of the wireless controller.

The object of the invention is illustrated on the drawing in which:

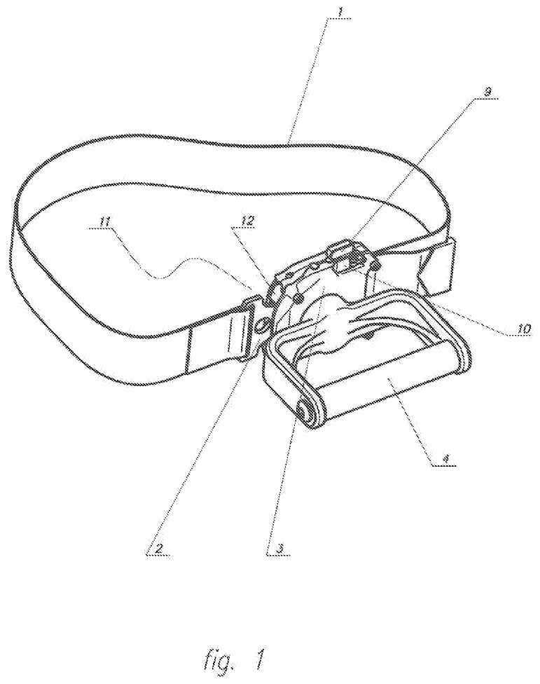

FIG. 1—shows the collar according to the invention in the first example of embodiment from the handle side, with the fastener fastened,

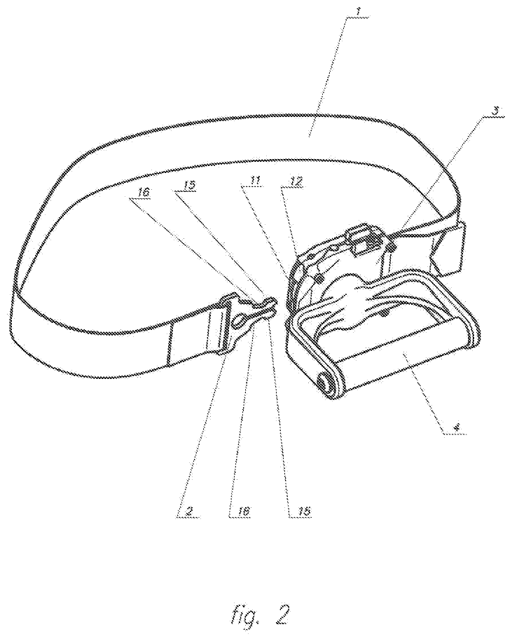

FIG. 2—the collar from FIG. 1, with the fastener unclipped,

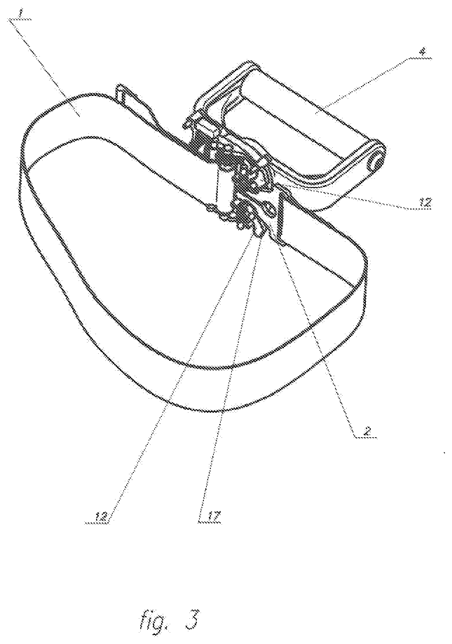

FIG. 3—the collar in the first example of embodiment, from the side of the adjustment mechanism, with the fastener fastened,

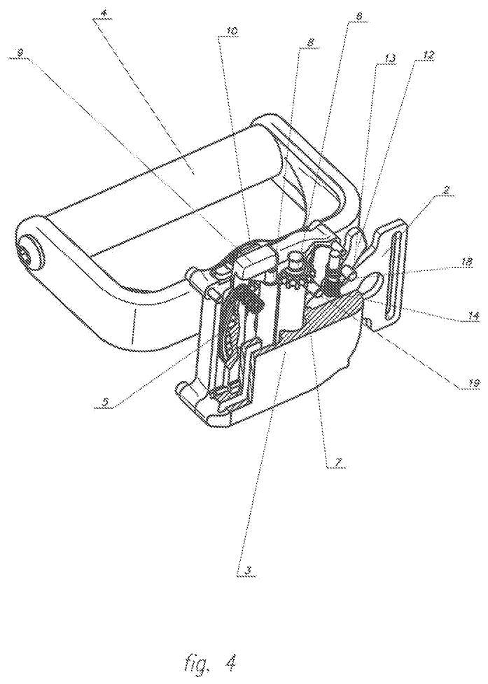

FIG. 4—detail of adjustment mechanism with fastener fastened,

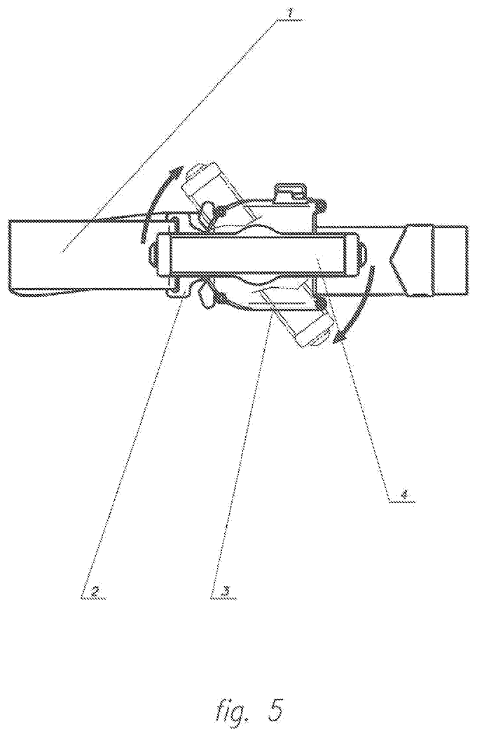

FIG. 5—diagram of handle movement,

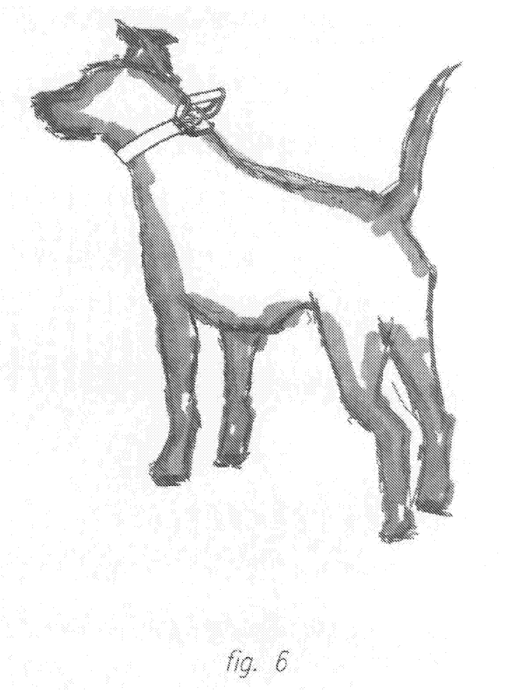

FIG. 6—the collar in the first example of embodiment on the outline of the dog's silhouette,

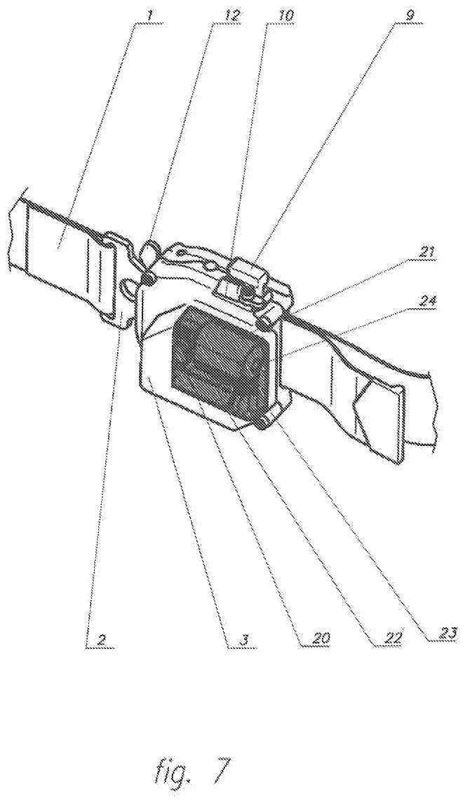

FIG. 7—the collar in the second example of the embodiment of the invention, from the side of the wireless control unit, with the fastener fastened,

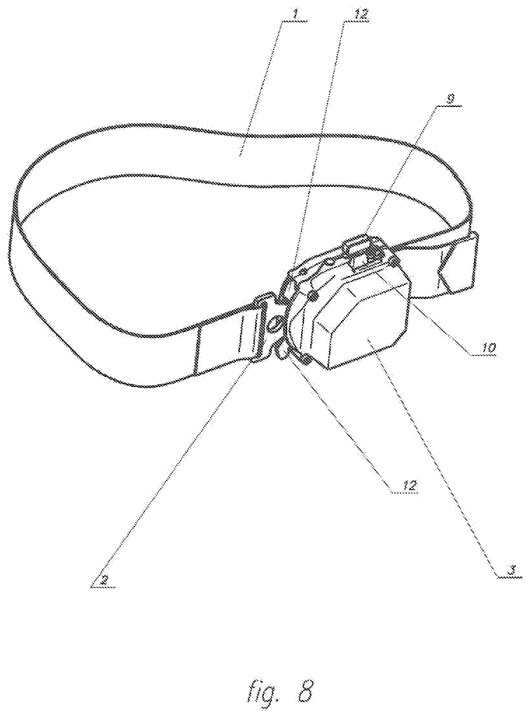

FIG. 8—adjustment device from FIG. 7 with a section of the housing torn out and sections of the collar strap, with fastener fastened.

In the first example of an embodiment, the collar according to the invention has a strap 1, at the free end of which a fastener 2 is embedded. On the section of strap 1 opposite to the fastener 2, there is a body 3 of the adjusting mechanism, the drive source of which is a handle 4 axially coupled to a shaped disc 5 setting in motion a shaft 6 with a gear wheel 7, between which and a pressure roller 8 the material of belt 1 is seated. In this example embodiment of the invention, the shaft 6 is coated with a layer of elastomer to increase the coefficient of friction between the shaft 6 and the strap 1 embedded in the gap between the pressure roller 8 and the shaft 6. In addition, the movement of the shaped disc 5 in the direction of increasing the diameter of the loop is blocked by a ratchet mechanism 9, cooperating with a rotating release lever 10. In addition, within the seat 11 of the body 3 for the fastener 2 there are located two, opposite socket levers 12, pivotally seated on the first pins 13, between which a settling channel 14 for the arms 15 of the fastener 2 is formed. In doing so, the socket levers 12 are pressed against the picks 16 of the fastener 2 with their thrust surfaces 17 by the pressure exerted by the pressure springs 18 pushing against the second pins 19 of the socket levers 12.

The rotation of the handle 4 generates a torque, transmitted via the shaped disc 5 via the gear wheel 7 of the shaft 6 frictionally coupled to the strap 1, to the reciprocating movement of the strap 1.

In the second example of embodiment, there is a fastener 2 on the strap 1 of the collar and the opposite end of the strap 1 is seated in the body 3 of the adjusting mechanism having a slot 11 for the fastener 2, between a pressure roller 8 and a shaft 6 with a gear wheel 7, set in rotation by a shaped disc 5, whereby the shaped disc 5 is coupled via a worm gear 20 to a DC electric motor 21 powered by a battery 22 and controlled by a printed circuit board 23 coupled to a wireless receiver 24.

The torque generated at the motor shaft 21, via worm gear 20, is transmitted by the shaped disc 5 via shaft 6 with gear wheel 7 frictionally coupled to strap 1, to the reciprocating movement of strap 1.

In further examples of the embodiment of the invention, based on the second example, a GPS module and/or a vital signs monitoring sensor is embedded within the body 3, cooperating with the printed circuit board 23.

It is obvious to a person skilled in the art that in each of the cited embodiments of the invention, a method of adjusting the length of the collar loop is implemented comprising the translation of the torque of the drive member is translated into the rotation of the shaft frictionally coupled to the belt material and is then translated into the reciprocating motion of the collar belt material, the torque of the drive member in the first direction of rotation being translated by the rotation of the shaft frictionally coupled to the belt material into the reciprocating motion of the collar belt in the first direction, and the torque of the drive member in the second direction of rotation is translated by rotation of the shaft frictionally coupled to the belt material into the reciprocating motion of the collar belt in the second direction, the translation of the reciprocating motion of the belt material by rotation of the shaft frictionally coupled thereto into the torque of the drive member being mechanically interlocked, and furthermore the mechanical interlocking of the translation of the reciprocating motion of the belt material by rotation of the shaft frictionally coupled thereto into the torque of the drive member is compensated for by external pressure on the locking (ratchet) mechanism.

1. A collar for pets, having the form of a strap, on a free end of which there is located a fastener, seated in a body cavity characterized in that a section of the strap of the collar opposite to the fastener is threaded through an adjustment mechanism located in the body cavity, whereby this adjustment mechanism is an arrangement of a pressure roller and a shaft parallel to said pressure roller with a toothed wheel between which there is a slot for the strap of the collar, whereby the toothed wheel is driven by the rotational movement of a shaped disc cooperating with the toothed wheel, the shaped disc being set in motion by a drive source, the rotational movement of the shaped disc being blocked by a ratchet mechanism.

2. The collar according to claim 1, characterized in that the drive source is a handle rotatably mounted in the body cavity of the adjustment mechanism and axially coupled to the shaped disc.

3. The collar according to claim 1, characterized in that the drive source is an electric motor coupled to the shaped disc via a worm gear and powered by a battery, the electric motor, the battery and the worm gear being situated in the body.

4. The collar according to claim 3, characterized in that the direction of rotation of the electric motor is controlled by a printed circuit board connected to the battery and a wireless receiver.

5. The collar according to claim 4, characterized in that the wireless receiver operates in the infrared band.

6. The collar according to claim 4, characterized in that the wireless receiver operates in the bluetooth band.

7. The collar according to claim 1, characterized in that the ratchet mechanism has a rotatable release lever.

8. The collar according to claim 1, characterized in that in the body cavity the socket for the fastener comprises at least one socket lever configured to release the fastener.

9. The collar according to claim 1, characterized in that the strap is made of a polyamide.

10. A method of adjusting the length of a collar loop of a collar, characterized in that a torque of all drive member is translated into rotation of a shaft frictionally coupled to a strap material of the collar and is then translated into a reciprocating movement of the strap material.

11. The method according to claim 10, characterized in that the torque of the drive member in a first direction of rotation is translated by rotation of the shaft frictionally coupled to the strap material into a reciprocating movement of the strap material of the collar in the first direction, and the torque of the drive member in a second direction of rotation is translated by rotation of the shaft frictionally coupled to the strap material into a reciprocating movement of the strap material of the collar in the second direction.

12. The method according to claim 11, characterized in that the translation of the reciprocating movement of the strap material by rotation of the shaft frictionally coupled thereto by friction to the torque of the drive member is mechanically locked.

13. The method according to claim 12, characterized in that the mechanical blocking of the translation of the reciprocating movement of the strap material by rotation of the shaft frictionally coupled thereto by friction to the torque of the drive member is nullified by external pressure on the blocking mechanism.

14. The collar according to claim 2, characterized in that the ratchet mechanism has a rotatable release lever.

15. The collar according to claim 3, characterized in that the ratchet mechanism has a rotatable release lever.

16. The collar according to claim 2, characterized in that in the body cavity, the socket for the fastener comprises at least one socket lever configured to release the fastener.

17. The collar according to claim 3, characterized in that in the body cavity, the socket for the fastener comprises at least one socket lever configured to release the fastener.

18. The collar according to claim 14, characterized in that in the body cavity, the socket for the fastener comprises at least one socket lever configured to release the fastener.

19. The collar according to claim 15, characterized in that in the body cavity, the socket for the fastener comprises at least one socket lever configured to release the fastener.

20. The collar according to claim 4, characterized in that the ratchet mechanism has a rotatable release lever.
